(19) United States
(12) Patent Application Publication
(10) Pub. No.: US 2013/0315513 A1
(43) Pub. Date: Nov. 28, 2013

(54) TRIBOLOGICAL PAIR AND PROCESS FOR SURFACE TREATMENT IN TRIBOLOGICAL PAIRS

(71) Applicants: Adilson Luiz Manke, Joinville - Sc (BR); Antonio Tadeu Cristofolini, Joinville - Sc (BR); Marcos Guilherme Schwarz, Joinville - Sc (BR)

(72) Inventors: Adilson Luiz Manke, Joinville - Sc (BR); Antonio Tadeu Cristofolini, Joinville - Sc (BR); Marcos Guilherme Schwarz, Joinville - Sc (BR)

(73) Assignee: WHIRLPOOL S.A., São Paulo -Sp (BR)

(21) Appl. No.: 13/991,138

(22) PCT Filed: Dec. 2, 2011
(86) PCT No.: PCT/BR2011/000451

§ 371 Date: Aug. 8, 2013

(30) Foreign Application Priority Data
Dec. 3, 2010 (BR) PI1005091-4

(51) Int. Cl. F16C 33/12; C23C 28/00

(52) U.S. Cl. CPC F16C 33/121; C23C 28/00
USPC 384/13; 427/402; 427/405; 427/419.1; 384/42

(57) ABSTRACT

The present invention is applied to a tribological pair comprising two metal pieces, a first of them having a movable contact surface which provides friction in relation to a respective contact surface of a second of said metal pieces. According to the present invention, the first metal piece has its contact surface defined by a coating formed: by a first surface layer in a material harder than that of the first metal piece; and by a second surface layer, disposed onto the first surface layer and in a material defining a coating which reduces the chemical affinity in relation to the contact surface of the second metal piece of the tribological pair, in order to provide, to said tribological pair, a lower friction coefficient in relation to the tribological pair deprived of said coating.

### FIELD OF THE INVENTION

The present invention refers to a tribological pair of the type defined by pieces with relative movement to each other, each having a respective contact surface, and to a process for treating the contact surfaces of the elements or pieces of a tribological pair.

### BACKGROUND OF THE INVENTION

Alternatives to reciprocating compressors for household and commercial refrigeration systems are continuously being searched, aiming to increase the energy efficiency of said machines. One of the ways to attain said object is by reducing the mechanical losses of the movable components (tribological pairs), which losses are generated by the relative movement between the tribological pairs, such as: crankshaft and bearing; piston pin and smaller eye of the connecting rod; eccentric pin and larger eye of the connecting rod; and spherical connections between the connecting rod and parts coupled thereto.

The mechanical loss between the tribological pairs in relative movement, such as, for example, between crankshaft and bearing is generated according to the following parameters:

Losses by contact between the surfaces:

Pot=Fa×ω×R, where Fa=μ×N;

Viscous-friction losses:

Pot=cte×f(ε)×(η×ω²×R³×L)/c,

in which:

Pot=>power generated by the friction;

Fa=>friction force;

ω=>relative angular speed between the surfaces;

R=>shaft radius;

μ=>dynamic friction coefficient;

N=>normal force;

η=>oil viscosity;

L=>useful width of the bearing;

c=>radial gap between the surfaces;

ε=>eccentricity relation between shaft and bearing.

It should be noted that the coefficient of dynamic friction produced by the lubricated contact between two surfaces is, at least, one order of magnitude higher than the viscous friction coefficient in a thick-film regime (typical values of 0.1 and 0.01, respectively, for metal components with conventional finishing by grinding and/or burnishing, with Ra values smaller than 0.5 μm).

Mainly in the first operating hours, there occurs a considerable amount of mechanical loss, due to friction generated by the contact between the surfaces, caused by inadequate surface finishing, great shape errors or even undersizing of the bearings. Depending on the intensity of this contact, there may occur a degeneration of the surfaces (mechanical, geometric and surface finishing properties), leading to failure of the bearings by wear. In most tribological pairs, it is technically unfeasible to dimension the bearings with the purpose of ensuring the total lack of contact between the surfaces which form said pair, whether as a matter of layout (available space), operating regimes (turn on/turn-off, extreme conditions, etc.), final cost or even due to limitations generated by the optimum commitment of other engineering parameters (trade-off).

Thus, there are usually employed especial finishings and/or surface coatings which minimize the harmful effects of said contacts.

In a mechanism of the connecting rod-crankshaft type, a typical example is the tribological pair (bearing) defined by the piston pin and by the smaller eye of the connecting rod. Due to the relative oscillating movement between these two components (piston pin and smaller eye), the speed is continuously variable and reaches zero twice during a compression cycle. This oscillatory pattern impairs the formation of a hydrodynamic pressure field, requiring relatively large dimensions for both the piston pin and the smaller eye, in order to avoid (or at least significantly minimize) the metal contact.

On the other hand, it is desirable that the piston pin has reduced dimensions for the following reasons:
the mass of the piston pin is reduced;
the smaller the piston pin, the smaller will be the dimensions of the smaller eye;
the smaller the piston pin and the smaller eye, the more compact will be the piston;

the masses of all the components cited above having direct influence on the unbalance of the mechanism.

Thus, in said tribological pair, it is usual the development of high-intensity metal contacts, and the wear is minimized with the use of high-hardness surface treatments (with or without coating), such as cementing, hardening or nitriding the pin and steam treating or nitriding the smaller eye of the connecting rod.

Similar requests (and solutions) also occur (and are used) in the tribological pair composed of ball-joint mechanisms of the type having a semi-spherical housing and a sphere (or semi-sphere), said tribological pair often replacing the tribological pair consisting of piston pin and smaller eye of the connecting rod.

There are currently known and used the following alternatives for surface treatment of a tribological pair, such as the one consisting of the piston pin and the smaller eye of the connecting rod:
Piston pin: nitriding; or cementing+hardening+phosphating;
Smaller eye of the connecting rod (in pure iron or alloy iron obtained by a sintering process): steam treating+phosphating; or nitriding; or machining+phosphating; or steam treated matrix+machining+phosphating; or machining+nitriding.

The surface finishing alternatives are presented in an increasing order of cost, the machining being an alternative to the calibration of sintered components.

The machining operation produces the following advantages in relation to the calibration process:
in components without steam treatment, it produces the sealing of the pores (which commonly occur in sintered components), allowing the deposition of a more homogeneous phosphate layer;
it increases the Tp % (effective support area) to values close to 100%;
in steam treated components, it eliminates the iron oxide surface layer, usually subject to uncladding;
it can minimize the shape errors (cylindricity), since it eliminates the elastic deformations which are not corrected by the calibration process.

Nevertheless, the machining presents the following disadvantages:
it is a more expensive process than the calibration;
it presents a worse surface finishing (when typical machining finishing techniques are used); and
it usually increases the position errors (parallelism between the eyes of the connecting rod).

Regarding the spherical ball-joint, the currently used surface treatment alternatives are as follows:
Semi-spherical housing: surface treatment with phosphating or nitriding;
Sphere (or semi-sphere): surface treatment by hardening+phosphating.

Irrespective of whether the piece surface is defined by the base material itself (without any type of coating) or defined by a coating (obtained, for example, by steam treatment) the manganic phosphate is widely used and known as an excellent means to break the chemical affinity between tribological pairs made of similar materials, as well as an excellent solid lubricant, reducing the friction between pieces relatively movable to each other and minimizing wear, mainly during the first operating hours in the process known as softening.

The surface treatment process of the contact surfaces of metal components (sintered or not) which define de tribological pairs, by coating the contact surface through nitriding, is recognized as an excellent solution for reducing wear in components of tribological pairs submitted to high contact pressures. This solution is broadly used in the tribological pairs formed by the piston pin and smaller eye of the connecting rod and by the sphere and semi-spherical housing between the connecting rod and piston with a spherical ball-joint.

Due to the continuous search for compressors which are more energy-efficient, less noisy, smaller and less expensive, there is a continuous optimization of the mechanism, following some general guidelines, including:
reduction of the oil viscosity class;
reduction of the dimensions and mass of the components; and
increase of the refrigeration capacity (volumetric displacement) of the smaller platforms.

These factors directly increase the mechanical efforts and, consequently, increase the loads applied to the components of the mechanism, reflecting in greater deformations and contacts of the tribological pairs, making even the components coated by nitriding to present wear under certain operational conditions.

When two nitrided pieces are submitted to friction or abrasion, as it occurs in the tribological pairs consisting of bearings, connecting rods and pins, the chemical instability of the nitrides is responsible for an electrostatic attraction of the nitrided layers. Thus, there is reactivity between the coatings, which contributes to the wear process of the components (wear by chemical affinity).

### OBJECTS OF THE INVENTION

Hence, it is an object of the present invention to provide a tribological pair of the type defined by pieces in relative movement to each other, each having a respective contact surface, and which presents, even in load-increasing conditions applied to the components of the mechanism, less wear on the contact surfaces of the tribological pair.

Another object of the present invention is to provide a tribological pair which, in addition to the features mentioned above, presents reduced friction conditions, improving the lubricity of the contact surface.

A further object of the present invention is to provide a process for surface treatment in tribological pairs which allows obtaining pieces with contact surfaces presenting good lubricity and reduced wear.

Still a further object of the present invention is to provide a tribological pair, and a process for surface treatment in tribological pairs, such as cited above and with a relatively reduced cost.

### SUMMARY OF THE INVENTION

These and other objects are achieved through a tribological pair comprising two metal pieces, each having a movable contact surface which provides friction in relation to a respective contact surface of the other of said pieces, one of the pieces having its contact surface coated: by a first surface layer in a material presenting a surface hardness higher than that of the respective piece; and by a second surface layer, defining a coating which reduces the chemical affinity in relation to the contact surface of the other piece of the tribological pair, in order to provide to the latter a smaller friction coefficient and a higher wear resistance in relation to the tribological pair deprived of said coating. The objects of the present invention are also attained with a process for surface treatment in tribological pairs of the type which comprises two metal pieces, each having a movable contact surface which provides friction in relation to a respective contact surface of the other of said pieces, said process comprising the steps of: coating the contact surface of one of said pieces with a first surface layer, in a material presenting a surface hardness higher than that of the respective piece; and coating the first surface layer of said piece with a second surface layer, defining a coating which reduces the chemical affinity in relation to the contact surface of the other piece of the tribological pair, in order to provide, to the latter, a lower friction coefficient and a higher wear resistance in relation to the tribological pair deprived of said coating.

According to a particular aspect of the present invention, the first surface layer is a nitride coating and the second surface layer is a phosphate coating and, more particularly, a manganese phosphate coating.

### BRIEF DESCRIPTION OF THE DRAWINGS

The invention will be described below, with reference to the enclosed figures, given by way of example of constructive forms for the invention and in which:

FIG. 1 is a schematic partially-cut cross sectional view of two pieces of a tribological pair with its contact surfaces formed according to a first embodiment of the present invention;

FIG. 2 is a view similar to that of FIG. 1, but illustrating the contact surfaces formed according to a second embodiment of the present invention;

FIG. 3 is a schematic partially-cut cross sectional view of two pieces of a tribological pair with its contact surfaces formed according to a third embodiment of the present invention; and

FIG. 4 is a view similar to that of FIG. 2, but illustrating the contact surfaces formed according to a forth embodiment of the present invention.

### DESCRIPTION OF THE INVENTION

Although comments on the prior art and its current limitations have been strongly associated with design requirements and mechanical efforts in the reciprocating refrigeration compressors, particularly those with reduced dimensions, it should be noted that the present invention can be applied to different tribological pairs which present operational conditions similar to those discussed for said compressors.

As already previously mentioned, the tribological pair object of the present invention comprises two metal pieces 10, 20, one of them having a movable contact surface 10a which provides friction in relation to a respective contact surface 20a of a second of said metal pieces 20.

As commented in more detail below, the two metal pieces 10, 20 of the tribological pair considered herein are generally obtained in any of the following materials: cemented steel or alloy steel with high surface hardness usually obtained by thermal treatment, low carbon steel, pure iron, alloy iron, cast iron and other ferrous/metal alloys.

According to the invention, the first of said metal pieces 10 has its contact surface 10a defined by a coating formed: by a first surface layer 11 in a material with hardness higher than that of the respective first metal piece 10; and by a second surface layer 12, disposed onto the first surface layer 11 and defining a coating which reduces the chemical affinity in relation to the contact surface 20a of the second metal piece 20 of the tribological pair, so as to provide, to the latter, a lower friction coefficient and a higher wear resistance in relation to the tribological pair without said coating.

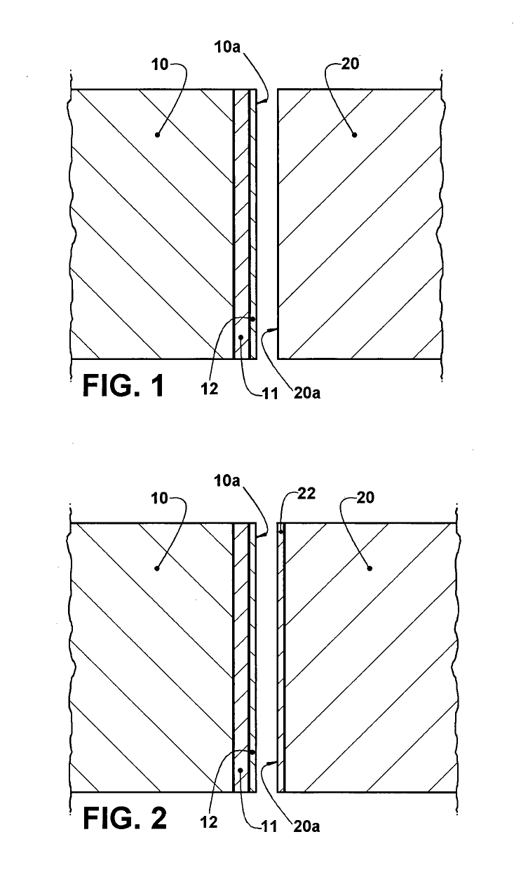

In a first embodiment of the invention, illustrated in FIG. 1, the second metal piece 20 has its contact surface 20a defined by the same material of said second metal piece 20, since the latter does not receive any coating.

Regardless of whether one of the metal pieces 10, 20 is provided or not with a coating on its contact surface 10a or 20a, both pieces are generally submitted to a surface finishing for example, by grinding, burnishing, brushing, sanding, calibration, etc., aiming at eliminating or at least minimizing the surface roughness peaks, deformations and surface irregularities.

According to the invention, the second surface layer 12 of the coating of the first metal piece 10 is defined in a solid lubricant material, preferably in phosphate and, more preferably, in manganese phosphate. This second surface layer 12 is obtained by means of a phosphating operation of said first metal piece 10, after the formation of the first surface layer 11.

The second surface layer 12 of the first metal piece 10 is formed onto a first surface layer 11 in nitride, that is, obtained by means of a nitriding operation of said first metal piece 10, before the latter being submitted to a phosphating operation.

For the construction in which the first metal piece 10 is coated by the first and second surface layers 11, 12, the contact surface 20a of the second metal piece 20 of the tribological pair may present any constitution, such as being surface coated by a phosphate, as the second embodiment illustrated in FIG. 2.

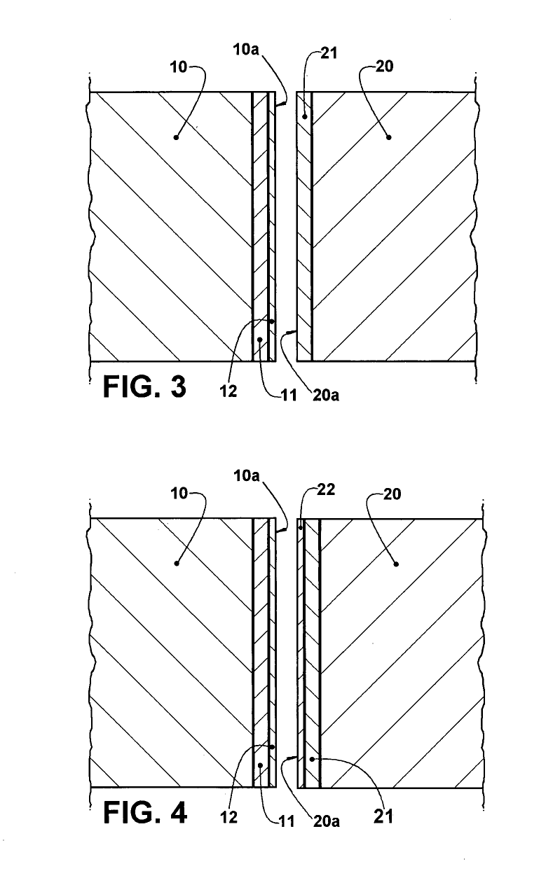

According to the third embodiment illustrated in FIG. 3, the second metal piece 20 may be provided with a coating defined by an external surface layer 21, in a material harder than that which forms said second metal piece 20, such as for example, that defined for the first surface layer 11 of the first metal piece 10.

In a way of carrying out the present invention, in which the desired results are obtained, the surface layer 21 of the second metal piece 20 is formed in nitride, that is, by means of a nitriding operation of said second metal piece 20.

According to a fourth embodiment of the present invention, as illustrated in FIG. 4, the second metal piece 20 may be provided with a second surface layer 22 defined in a solid lubricant material, for example, a phosphate. This second surface layer 22 is obtained by means of a phosphating operation of the second metal piece 20, after the formation of the first surface layer of the latter, as described above regarding the formation of the coating of the first metal piece 10.

In this case, the first surface layer 21 may be defined in a material harder than that which forms said second metal piece 20 such as, for example, that defined for the first surface layer 11 of the first metal piece 10.

It should be understood that the two metal pieces 10, 20, even when provided with the respective coatings, as illustrated for the first metal piece 10 in FIG. 1 and for both pieces in FIGS. 2 to 4, may be previously submitted to treatments for improving the surface finishing, such as sanding or brushing, before the nitriding and phosphating operations, for example, which are capable of leading to a better incorporation of the coatings to the respective metal pieces, or even to a better surface finishing of said coatings.

The deposition of a manganic phosphate layer onto the nitriding coating reduces the harms mentioned in the previously discussed tribological pair constructions. The manganic phosphate is widely used and known as an excellent means to break the chemical affinity between pairs made of similar materials, as well as an excellent solid lubricant, reducing the friction and minimizing the wear, mainly during the first operating hours (known as softening), with no harm to the already known properties of the nitride layer, becoming a′solution with excellent tribological properties.

The solution of applying manganic phosphate onto the nitride also contributed to solve another potential problem: in the solutions in which the connecting rod of a reciprocating refrigeration compressor is a single piece (and not made of two pieces), it is possible to provide the same surface treatment for the two eyes of the connecting rod: smaller eye and larger eye.

Also regarding the application of the invention to reciprocating refrigeration compressors, in the tribological pair consisting of eccentric pin/larger eye, the lubricating regime tends to be hydrodynamic, but the misalignments produced by the deformation of the mechanism components also produce punctual contacts, increasing the contact pressures and, as a consequence, increasing the mechanical loss and/or wear. Since the eccentric pin of the crankshaft of reciprocating compressors is typically produced in cast iron or low carbon steel, both with low surface hardness, the formation of a tribological pair composed by these “soft” materials, and by another material having a high surface hardness (such as the nitride-coated larger eye) tends to produce a more intense (more severe) wear to the counterpart with a lower hardness, that is, to the eccentric pin of the crankshaft.

Particularly regarding the reciprocating refrigeration compressors, the deposition of a manganic phosphate layer, as a second surface layer 12 onto a first surface layer 11 obtained by nitriding, contributes to minimize the wear in the tribological pairs of the piston pin/smaller eye of the connecting rod and of the eccentric pin/larger eye of the connecting rod, as well as to reduce the mechanical loss in this last tribological pair, which loss can be very high during the initial moments of the compressor operation, when the lack of lubrication intensifies the contact between the surfaces.

According to the present invention, it is possible to have, in a reciprocating refrigeration compressor, the following combinations of tribological pairs which present one, or even two, of the contact surfaces 10a, 20a provided with the first and second surface layer 11, 12:

| | Smaller eye of the |
|---|---|
| Piston pin | connecting rod |
| steel (cemented or alloy) | Iron (pure or alloy) + |
| and hardened (with or | nitride + phosphate |
| without phosphate) | |
| steel (cemented or alloy) | Iron (pure or alloy) + |
| and hardened + nitride | nitride + phosphate |
| steel (cemented or alloy) | Iron (pure or alloy) + |
| and hardened + nitride + | nitride (with or without |
| phosphate | phosphate) |
| steel (cemented or alloy) | Iron (pure or alloy) + steam |
| and hardened + nitride + | treatment (with or without |
| phosphate | phosphate) |

| Ball-joint: | Ball-joint: |
|---|---|
| Semi-spherical housing | Sphere |
| steel (low carbon or alloy | hardened steel (with or |
| and hardened) + nitride + | without phosphate) |
| phosphate | |
| steel (low carbon or alloy | steel (low carbon or alloy |
| and hardened) + nitride + | and hardened) + nitride |
| phosphate | (with or without phosphate) |
| hardened steel (with or | steel (low carbon or alloy |
| without phosphate) | and hardened) + nitride + |
| | phosphate |
| steel (low carbon or alloy | steel (low carbon or alloy |
| and hardened) + nitride | and hardened) + nitride + |
| (with or without phosphate) | phosphate |

| | Larger eye of the |
|---|---|
| Eccentric pin | Connecting rod |
| cast iron or steel (with or | Iron (pure or alloy) + |
| without phosphate) | nitride + phosphate |

Regarding the construction of a single-piece connecting rod, both eyes can receive the surface treatment process of the present invention.

In the case of a construction of tribological pair in which at least one of the pieces presents a steam treated layer (with or without phosphate), it is also possible to coat the surface of the second piece with a more external phosphate layer over a nitride layer.

Specifically for the larger eye, the nitriding can bring loss of reliability and consumption, due to the operation made against a surface usually presenting a low hardness (of the eccentric pin). Thus, it becomes highly advantageous to provide the second phosphate surface layer over the first nitride surface layer in the larger eye of the connecting rod, so as to increase the reliability of this tribological pair (wear reduction during the softening process) and minimize the mechanical loss.

The present invention provides a solution for any tribological pairs which present the design and operating characteristics similar to those found in a reciprocating refrigeration compressor, such as piston pin and smaller eye of the connecting rod; spherical ball-joint; eccentric pin and larger eye of the connecting rod. As already mentioned, the second surface layer 22 has the following functions:
breaking the chemical affinity between nitrides, when it defines the coating of the contact surface of both metal pieces of a tribological pair, since one of the pieces is coated by nitride and the other by a double coating: a first surface layer 11 of nitride and a second surface layer 12 of phosphate;
retaining oil, since the second surface layer 12, containing phosphate, presents a porous structure, with spaces which permit oil retention; and
allowing conforming the irregularities of the bearing surface, since said second surface layer 12, containing phosphate, facilitates the conformation of the surface of one of the metal pieces of the tribological pair to the contact conditions with the surface of the other metal piece of said tribological pair.

In a particular form of the present invention, the second surface layer 12 defines a coating of manganese phosphate (reagent), which chemically and energetically stabilizes the nitrided surface, through an electrostatic shielding. Said reaction stabilizes the double coating (nitride/phosphate) and impedes the previously established chemical affinity between the nitrided surfaces of a conventional sliding system, with its nitrided contact surfaces. The presence of a stable agent (manganese phosphate) creates an energy barrier, reducing the electrostatic attraction between the coatings (nitride/nitride) and increasing the useful life of the pieces by reducing wear.

The construction of the tribological pair of the present invention allows providing a higher hardness and reducing the friction between the contact surfaces of the tribological pair, creating a chemical neutrality between the contact surfaces of the two metal pieces of the tribological pair, avoiding the adhesive wear. The second surface layer, the phosphated one, presents physical properties which allow it to conform to the imperfections existing on the first layer, creating an external surface which is more uniform and capable of better distributing the pressure and wear. This second surface layer, applied onto the first surface layer, acquires a better adherence, extending the life of the pieces in movable contact.

Although the description mentioned above presents the second surface layer 12 as being defined in a phosphate, it should be understood that this second surface layer 12 can be defined by other elements, such as chemical nickel and its variations, which present characteristics of solid lubricant, moldability and can reduce the chemical affinity with the contact surface material of the other piece of the tribological pair. The first surface layer which hardens the second metal piece can be also defined by thermal treatment (e.g. hardening) or steam treatment, provided that it produces the desired structural effect in the respective piece and allows applying, or not, a manganic phosphate coating.

The present invention also provides a process for surface treatment in tribological pairs of the type defined above, said process comprising the steps of: coating the contact surface 10a of the first of said metal pieces 10 with a first surface layer 11, in a material harder than that of the first metal piece 10; and coating the first surface layer 11 of the first metal piece 10 with a second surface layer 12, in a material defining a coating which reduces the chemical affinity in relation to the contact surface 20a of the second metal piece 20 of the tribological pair, so as to provide, to said tribological pair, a lower friction coefficient in relation to the tribological pair without said coating.

1. A tribological pair comprising two metal pieces, a first of them having a movable contact surface which provides friction in relation to a respective contact surface of a second of said metal pieces, characterized in that the first metal piece has its contact surface defined by a coating formed: by a first surface layer in a material harder than that of the first metal piece; and by a second surface layer disposed onto the first surface layer and defining a coating which reduces the chemical affinity in relation to the contact surface of the second metal piece of the tribological pair.

2. The tribological pair, as set forth in claim 1, characterized in that the second surface layer of the first metal piece is a solid lubricant.

3. The tribological pair, as set forth in claim 2, characterized in that the second surface layer of the metal piece is one of the materials defined by phosphate or chemical nickel.

4. The tribological pair, as set forth in claim 3, characterized in that the first surface layer of the first metal piece is a nitride coating and the second surface layer is a phosphate coating.

5. The tribological pair, as set forth in claim 3, characterized in that the second surface layer of the first metal piece is a manganese phosphate coating.

6. The tribological pair, as set forth in claim 1, characterized in that the second metal piece has its contact surface also coated by an external surface layer, in a material harder than that of said second metal piece.

7. The tribological pair, as set forth in claim 6, characterized in that said external surface layer of the second metal piece is defined by a nitride coating.

8. The tribological pair, as set forth in claim 1, characterized in that said contact surface of the second metal piece is defined by a coating in one of the materials defined by phosphate or chemical nickel.

9. The tribological pair, as set forth in claim 1, characterized in that the metal pieces which define the tribological pair are formed in one of the materials consisting of steel, iron, cast iron and alloys thereof.

10. A process for surface treatment in tribological pairs, of the type which comprises two metal pieces, a first of them having a movable contact surface which provides friction in relation to a respective contact surface of a second of said metal pieces, characterized in that it comprises the steps of: coating the contact surface of the first metal piece with a first surface layer, in a material harder than that of the first metal piece; and coating the first surface layer of said first metal piece with a second surface layer, defining a coating which reduces the chemical affinity in relation to the contact surface of the second metal piece of the tribological pair.

11. The process, as set forth in claim 10, characterized in that the second surface layer is a solid lubricant.

12. The process, as set forth in claim 11, characterized in that the second surface layer is defined by a coating in one of the materials consisting of phosphate or chemical nickel.

13. The process, as set forth in claim 12, characterized in that the first surface layer is a nitride coating and the second surface layer is a phosphate coating.

14. The process, as set forth in claim 12, characterized in that the second surface layer is a manganese phosphate coating.

15. The process, as set forth in claim 10, characterized in that it further comprises the step of coating the contact surface of the second metal piece with an external surface layer, in a material harder than that of said second metal piece.

16. The process, as set forth in claim 15, characterized in that said external surface layer of the second metal piece is defined by a nitride coating.

17. The process, as set forth in claim 10, characterized in that said contact surface of the second metal piece is defined by a coating in one of the materials consisting of phosphate or chemical nickel.

18. The process, as set forth in claim 10, characterized in that the metal pieces which define the tribological pair are formed in one of the materials consisting of steel, iron, cast iron and alloys thereof.
